(19) United States
(12) Patent Application Publication
(10) Pub. No.: US 2013/0341301 A1
(43) Pub. Date: Dec. 26, 2013

(54) METHOD FOR MANUFACTURING A CHIP RESISTOR

(71) Applicant: RALEC ELECTRONIC CORPORATION, Kaohsiung (TW)

(72) Inventor: Full Chen, Kaohsiung City (TW)

(73) Assignee: RALEC ELECTRONIC CORPORATION, Kaohsiung (TW)

(21) Appl. No.: 13/783,931

(22) Filed: Mar. 4, 2013

(30) Foreign Application Priority Data
Jun. 25, 2012 (TW) 101122620

(51) Int. Cl. H01C 17/00; H01C 7/00

(52) U.S. Cl. CPC H01C 17/006; H01C 7/00
USPC 216/20; 156/267; 156/150

(57) ABSTRACT

In a method of manufacturing a chip resistor, a semi-product is formed by sandwiching an electric-insulating material layer between an electric-conducting material layer and a heat-dissipating material layer. Resistor sections arranged in an array on the semi-product are formed by forming longitudinal first slots and transverse second slots through the semi-product. Slits are formed on a first layer of each resistor section to form a resistor main body. A dividing slot is formed on a second layer of each resistor section. Two electrodes are formed to be electrically connected to opposite ends of the resistor main body. The resistor sections are trimmed from the semi-product to obtain the chip resistors.

### CROSS-REFERENCE TO RELATED APPLICATION

This application claims priority of Taiwanese Patent Application No. 101122620, filed on Jun. 25, 2012, the disclosure of which is herein incorporated by reference.

### BACKGROUND OF THE INVENTION

1. Field of the Invention

This invention relates to a method for manufacturing a passive component, more particularly to a method for manufacturing a chip resistor.

2. Description of the Related Art

Referring to FIGS. 1 and 2, a conventional method for manufacturing a conventional chip resistor 1 includes the following steps. First, a metal sheet is rolled and trimmed to obtain a plurality of metal strips. Two electrode strips are electroformed on opposite sides of each metal strip. Each metal strip is cut to obtain a plurality of resistor sections each having two electrodes 13. Then, a plurality of slits 111 are formed on each resistor section and extend in a longitudinal direction (L), thereby obtaining a resistor main body 11 having a pair of ends 112 that are opposite to each other in a transverse direction (T) perpendicular to the longitudinal direction (L) and that are electrically and respectively connected to the electrodes 13. Every adjacent two of the slits 111 extend from and penetrate lateral sides of the resistor main body 11, respectively, thereby forming a serpentine current path and achieving a desired resistance value of the conventional chip resistor 1. Finally, opposite surfaces of the resister main body 11 are coated respectively with two coating layers 12 to obtain the conventional chip resistor 1.

The resistance value of a resistor is directly proportional to a product of an electrical resistivity of the material of the resistor and a length of current path, and is inversely proportional to a cross-sectional area of the resistor in thickness. Accordingly, in order to increase the resistance value of the conventional chip resistor 1, the thickness of the resistor main body 11 is decreased and/or a number of the slits 111 is increased for lengthening the length of a current path, resulting in a relatively weak structural strength of the conventional chip resistor 1.

Moreover, since the coating layers 12 cover the opposite surfaces of the resistor main body 11, it is difficult to dissipate heat generated by the resistor main body 11 and temperature of the conventional chip resistor 1 is thus increased dramatically during use. As a consequence, the resistance value and the resistance characteristic of the conventional chip resistor 1 is affected adversely due to the increased temperature. Additionally, the coating layers 12 have to be made of a heat-resistant material and thus manufacturing cost of the conventional chip resistor 1 is increased.

### SUMMARY OF THE INVENTION

The object of the present invention is to provide a method for manufacturing a chip resistor having relatively good structural strength and capable of dissipating heat effectively.

According to this invention, the method comprises the following steps of:

a) sandwiching an electric-insulating material layer between an electric-conducting material layer and a heat-dissipating material layer to form a semi-product;

b) forming a plurality of resistor sections arranged in an array on the semi-product by
forming a plurality of first slots through the semi-product, the first slots extending in a first direction and being arranged in a plurality of rows, each row including a plurality of adjacent pairs of the first slots, and
forming a plurality of second slots through the semi-product, the second slots extending in a second direction perpendicular to the first direction and being arranged in a plurality of columns, each adjacent pair of the second slots cooperating with a corresponding adjacent pair of the first slots to surround and define one of the resistor sections, each of the resistor sections having a first layer which is a segment of the electric-conducting material layer, a second layer which is a segment of the heat-dissipating material layer, and a sandwiched layer which is a segment of the electric-insulating material layer;

c) for each resistor section, forming a plurality of slits on the second layer of the resistor section to form a resistor main body, the slits extending in the first direction and being arranged and spaced apart from one another in the second direction, the resistor main body having a pair of ends opposite to each other in the second direction and corresponding respectively to a pair of the first slots that define the resistor section;

d) for each resistor section, forming at least one dividing slot on the third layer of the resistor section, the dividing slot projectively crossing at least one of the slits of the resistor section and dividing the third layer of the resistor section into at least two portions that are spaced apart from each other in the second direction;

e) for each resistor section, forming two electrodes that are electrically and respectively connected to the ends of the resistor main body; and

f) trimming each of the resistor sections to obtain a chip resistor.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional chip resistor manufactured by a conventional method;

FIG. 2 is a schematic top view of the conventional chip resistor;

FIG. 3 is a flow chart illustrating a preferred embodiment of a method of manufacturing a chip resistor according to the present invention;

FIG. 4 is a perspective view of a semi-product that is formed during manufacture of the chip resistor;

FIG. 5 is a perspective view of the semi-product formed with a plurality of resistor sections arranged in an array;

FIG. 6 is a fragmentary enlarged view of FIG. 5;

FIG. 7 is a schematic bottom view of the semi-product, where each of the resistor sections is formed with a plurality of slits to form a resistor main body;

FIG. 8 is a schematic top view of the semi-product, where each of the resistor sections is formed with a dividing slot;

FIG. 9 is a schematic top view of the semi-product, where two electrodes are formed on opposite ends of each resistor main body;

FIG. 10 is a perspective view of the chip resistor made by the method of the preferred embodiment;

FIG. 11 is a schematic bottom view of the chip resistor;

FIG. 12 is a schematic top view of the chip resistor for illustrating the dividing slot that has two segments forming an obtuse angle therebetween;

FIG. 13 is a schematic top view of the chip resistor for illustrating a modification of the dividing slot that includes a plurality of segments in a zigzag arrangement; and

FIG. 14 is a schematic top view of the chip resistor for illustrating a heat dissipating layer of the chip resistor formed with a plurality of dividing slots.

### DETAILED DESCRIPTION OF THE PREFERRED EMBODIMENT

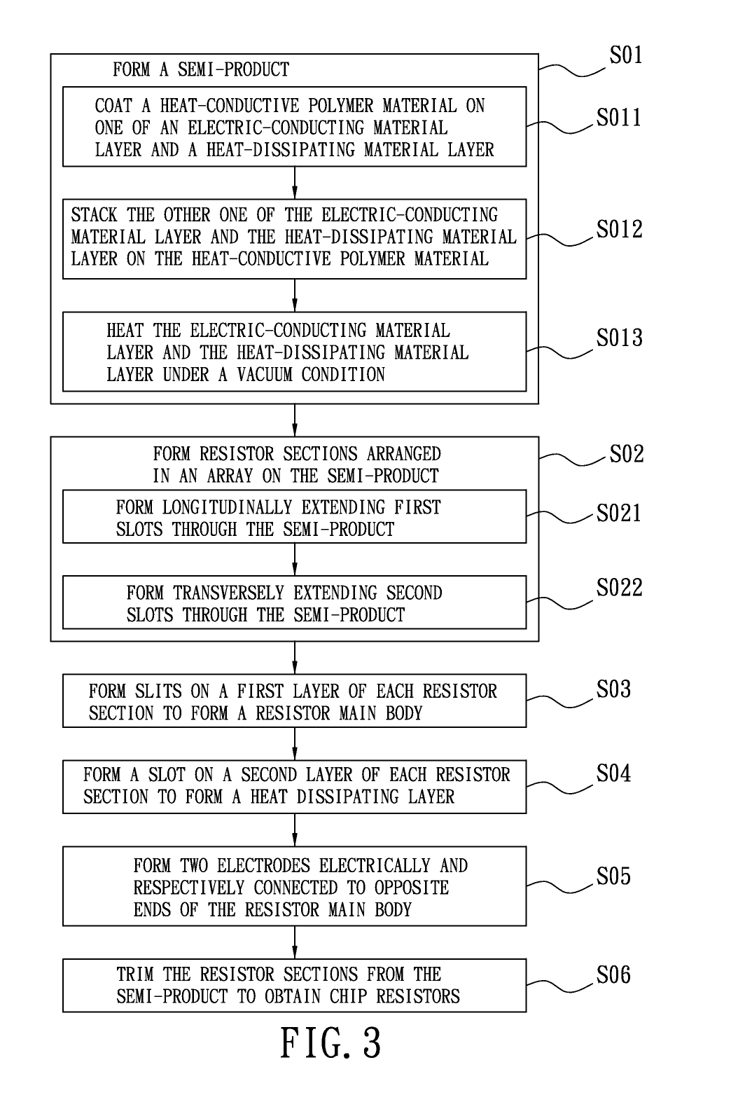

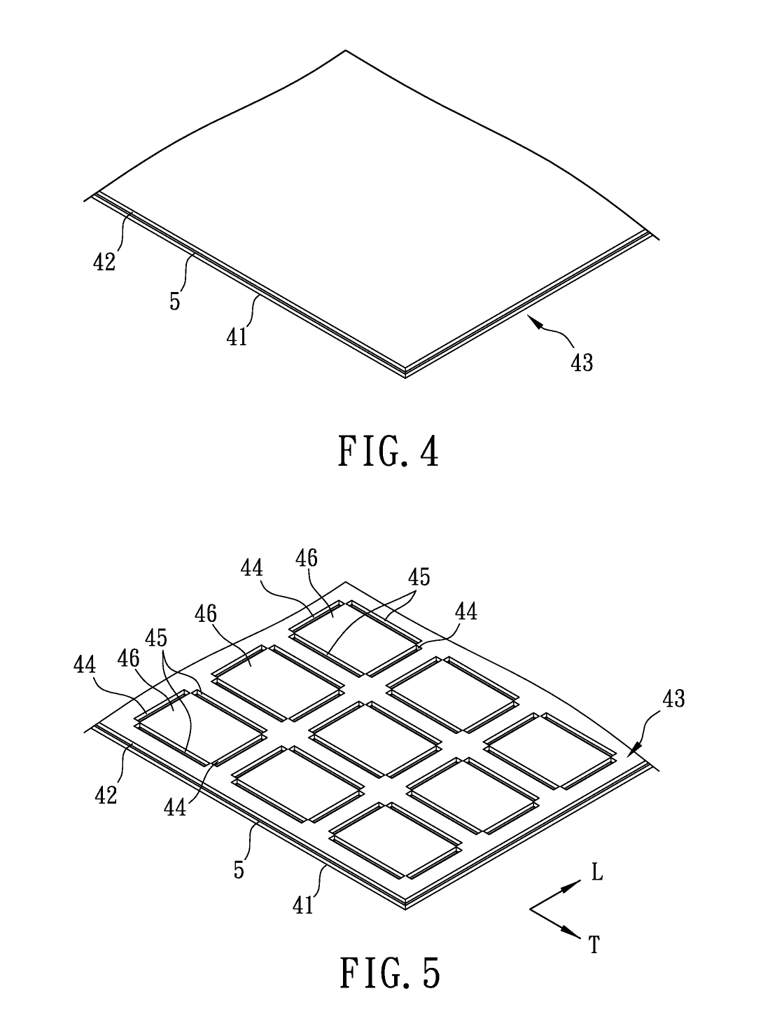

Referring to FIG. 3, a preferred embodiment of a method of manufacturing a chip resistor is shown to include the following steps. As shown in FIG. 4, in step S01, an electric-insulating material layer 5 is sandwiched between an electric-conducting material layer 41 and a heat-dissipating material layer 42 to form a semi-product 43 by the following sub-steps. In sub-step S011, a heat-conductive polymer material is coated on one of the electric-conducting material layer 41 and the heat-dissipating material layer 42. In sub-step S012, the other one of the electric-conducting material layer 41 and the heat-dissipating material layer 42 is stacked on the heat-conductive polymer material. In sub-step S013, the electric-conducting material layer 41 and the heat-dissipating material layer 42 are heated under a vacuum condition to solidify the heat-conductive polymer material serving as the electric-insulating material layer 5, thereby forming the semi-product 43.

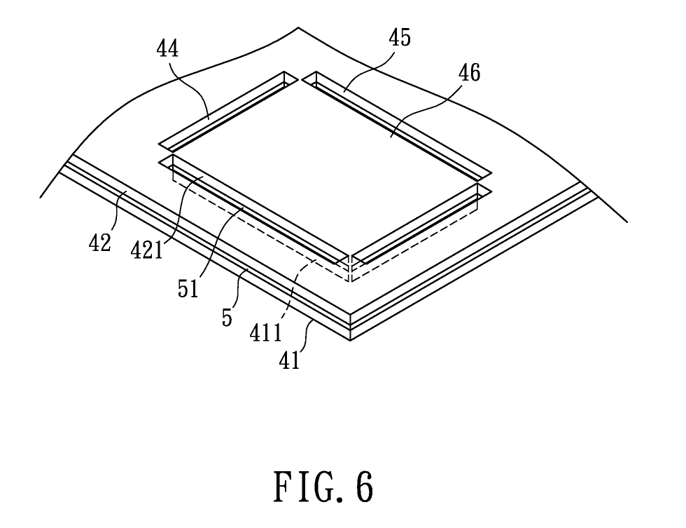

Further referring to FIGS. 5 and 6, in step S02, a plurality of resistor sections 46 arranged in an array are formed on the semi-product 43 by the following sub-steps. In sub-step S021, a plurality of first slots 44 are formed through the semi-product 43. The first slots 44 extend in a longitudinal direction (L) and are arranged in a plurality of rows. Each row of the first slots 44 includes a plurality of adjacent pairs of the first slots 44. In sub-step S022, a plurality of second slots 45 are formed through the semi-product 43. The second slots 45 extend in a transverse direction (T) perpendicular to the longitudinal direction (L) and are arranged in a plurality of columns. Each adjacent pair of the second slots 45 cooperate with a corresponding adjacent pair of the first slots 44 to surround and define one of the resistor sections 46. Each of the resistor sections 46 has a first layer 411 which is a segment cut from the electric-conducting material layer 41, a second layer 421 which is a segment cut from the heat-dissipating material layer 42, and a sandwiched layer 51 which is a segment cut from the electric-insulating material layer 5.

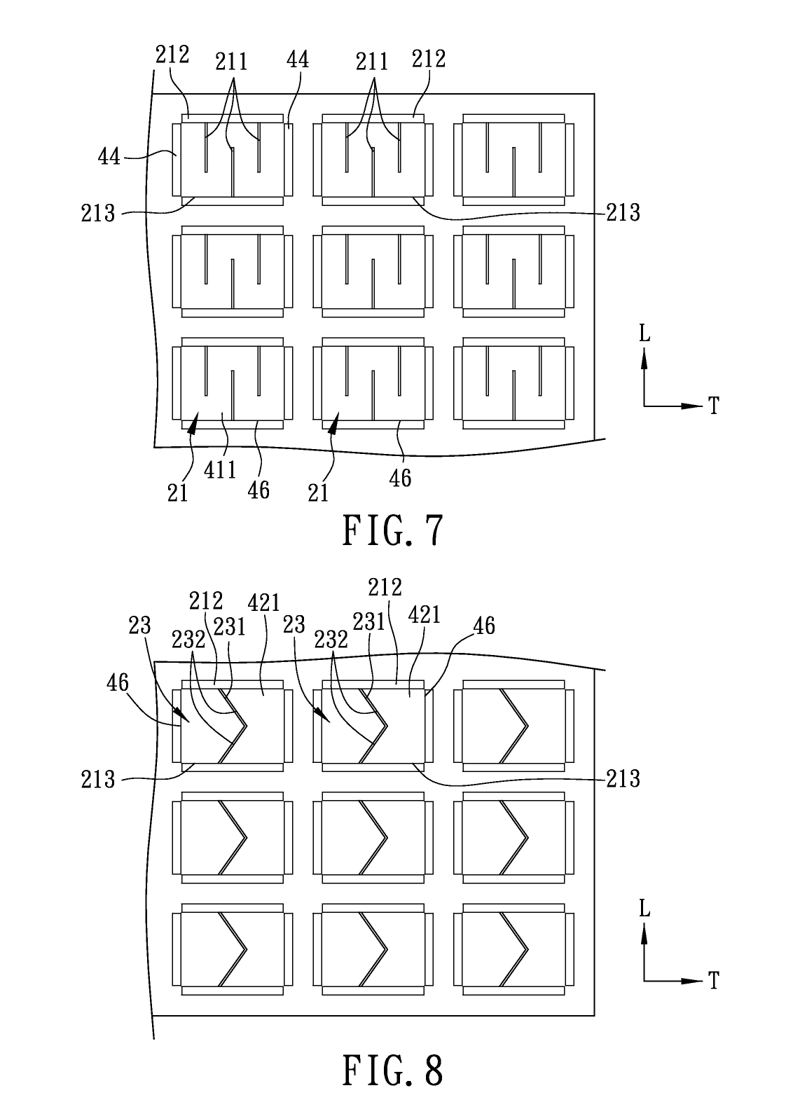

Referring to FIG. 7, in step S03, for each resistor section 46, a plurality of slits 211 are formed on the first layer 411 of the resistor section 46 by masking and etching to form a resistor main body 21. The slits 211 extend in the longitudinal direction (L) and are arranged and spaced apart from one another in the transverse direction (T). The resistor main body 21 has a pair of ends 214 and a pair of lateral sides 212, 213. The ends 214 are opposite to each other in the transverse direction (T) and correspond respectively to an adjacent pair of the first slots 44 in the row that define the resistor section 46. The lateral sides 212, 213 parallelly extend in the transverse direction (T) and opposite to each other in the longitudinal direction (L). Every adjacent two of the slits 211 extend from and penetrate through the lateral sides 212, 213, respectively. By this configuration, current flows through the resistor main body 21 along a serpentine current path (i.e., a zigzag current path), and a desired resistance value of the chip resistor made by the method of this embodiment can be achieved. Note that, although the resistor main body 21 is formed with three slits 211 in this embodiment, the number of the slits 211 can be varied according to a desired resistance value in other embodiments.

Referring to FIG. 8, in step S04, for each resistor section 46, a dividing slot 231 is formed on the second layer 421 of the resistor section 46 by masking and etching to from a heat dissipating layer 23. The dividing slot 231 divides the second layer 421 of the resistor section 46 into two portions that are spaced apart from each other in the transverse direction (T) and is formed to have two segments 232 which form an obtuse angle therebetween and each of which extends inclinedly from one of the lateral sides 212, 213 toward the other one of the lateral sides 212, 213.

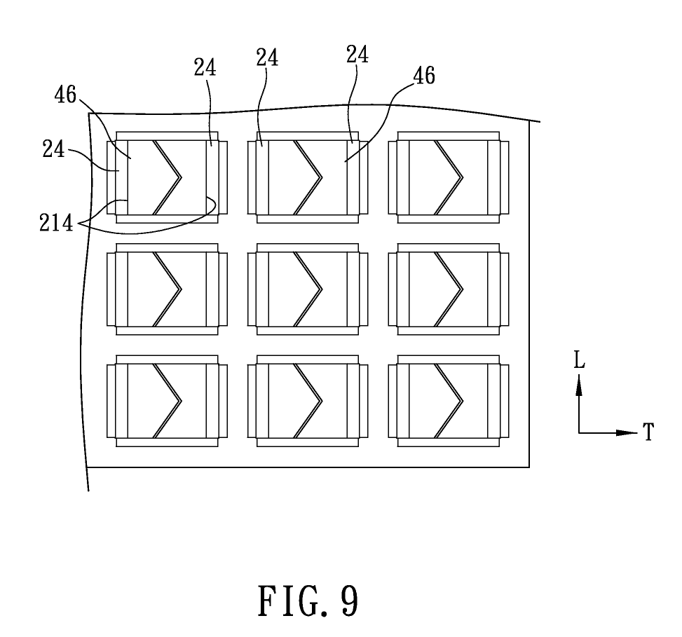

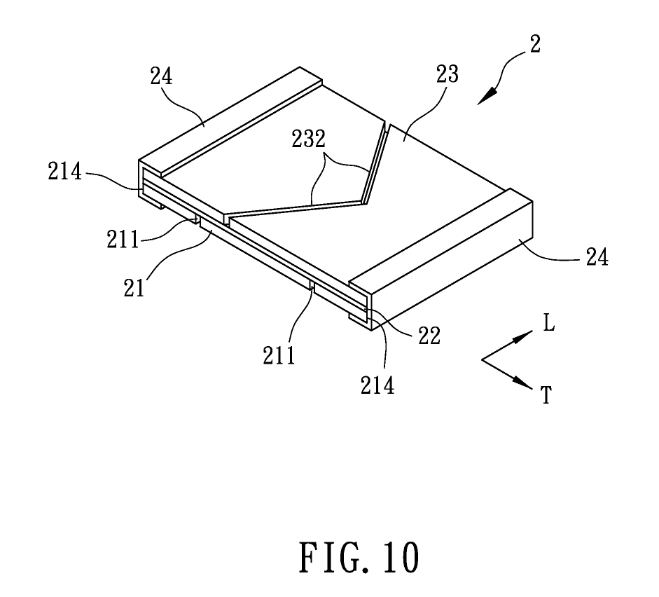

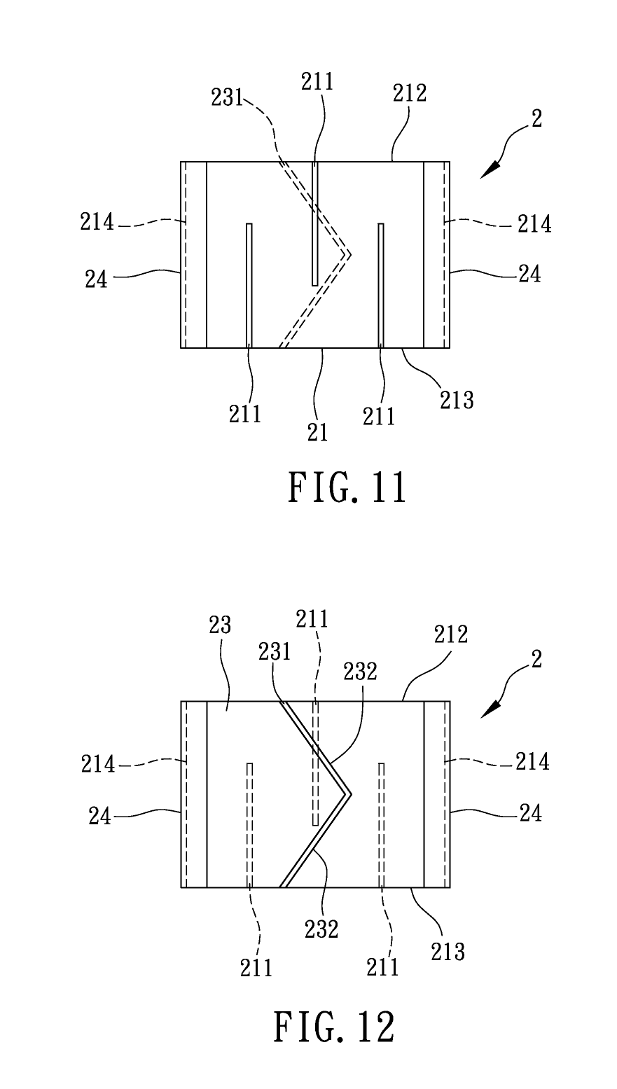

Referring to FIG. 9, in step S05, for each resistor section 46, two electrodes 24 are formed to be electrically and respectively connected to the ends 214 of the resistor main body 21 by masking and electroplating. Finally, in step S06, each of the resistor sections 46 is trimmed from the semi-product 43 to obtain the chip resistor 2 illustrated in FIGS. 10 to 12.

As shown in FIGS. 10 to 12, each chip resistor 2 includes the resistor main body 21 made of the first layer 411, the heat dissipating layer 23 made of the second layer 421, an insulating layer 22 made from the sandwiched layer 51, and the electrodes 24. The insulating layer 22 is electrically insulating the heat dissipating layer 23 from the resistor main body 21, the heat dissipating layer 23 is for dissipating heat generated by the resistor main body 21 during use of the chip resistor 2, and the electrodes 24 are electrically connected to an electronic device such as a circuit board (not shown).

The electric-insulating material layer 5 has relatively great thermal conductivity and is made of a polymer material, such as polypropylene, so that the insulating layer 22 thus made facilitates conduction of the heat generated by the resistor main body 21 to the heat dissipating layer 23. The electric-conducting material layer 41 and the heat-dissipating material layer are made of a material selected from the group consisting of copper, aluminum, copper alloy, aluminum alloy, and copper aluminum alloy. Since the heat dissipating layer 23 is formed with the dividing slot 231, current will not flow through the heat dissipating layer 23.

In use, current flows from one of the electrodes 24 through the resistor main body 21 via the current path (see FIG. 10) toward the other one of the electrodes 24. The heat generated by the resistor main body 21 can be effectively transmitted through the insulating layer 22 to the heat dissipating layer 23, and then, is dissipated to the ambient. As a result, the temperature of the chip resistor 2 remains relatively low as compared to the conventional chip resistor 1, and the resistance value and resistance characteristic of the chip resistor 2 are not affected. Additionally, since the heat dissipation capability of the chip resistor 2 is relatively good, it is not necessary to select a heat-resistant material for manufacturing the chip resistor 2 thereby reducing manufacturing cost.

The resistance value of the chip resistor 2 is determined by the material of the resistor main body 21, a cross-sectional area of the resistor main body 21, and a length of the current path. When the thickness of the resistor main body 21 is reduced and/or the number of slits 211 formed on the resistor main body 21 is increased in order to increase the resistance value of the chip resistor 2, the structural strength of the chip resistor 2 can be ensured by virtue of the heat dissipating layer 23 that is made of metallic material. Additionally, since the dividing slot 231 extends across one of the slits 211, there is no stress concentration on the resistor main body 21 and the heat dissipating layer 23. As a result, the chip resistor 2 of the present invention can be applied to a wider range of resistance values.

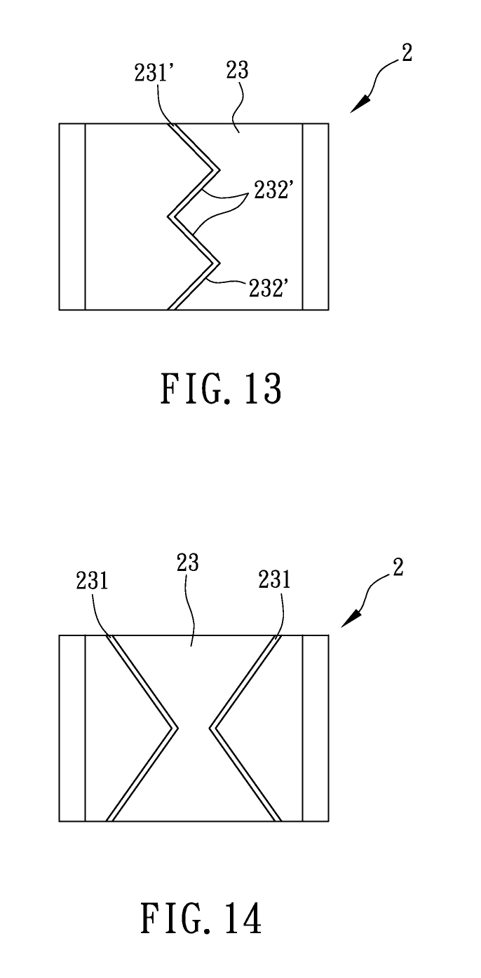

Referring to FIGS. 13 and 14, two modifications of the dividing slot 231, 231′ can be made by modifying a mask for etching in step S04. As shown in FIG. 13, the dividing slot 231′ is formed to have a plurality of segments 232′ in a zigzag arrangement, and every adjacent two of the segments 232′ form an obtuse angle therebetween. As shown in FIG. 14, two dividing slots 231 are formed on the heat dissipating layer 23 by etching two dividing slots 231 on the second layer 421 of the resistor section 46 in step S04. The dividing slots 231 divide the heat dissipating layer 23 into three spaced-apart portions in the transverse direction (T), and two of them extend across two of the slits 211, respectively.

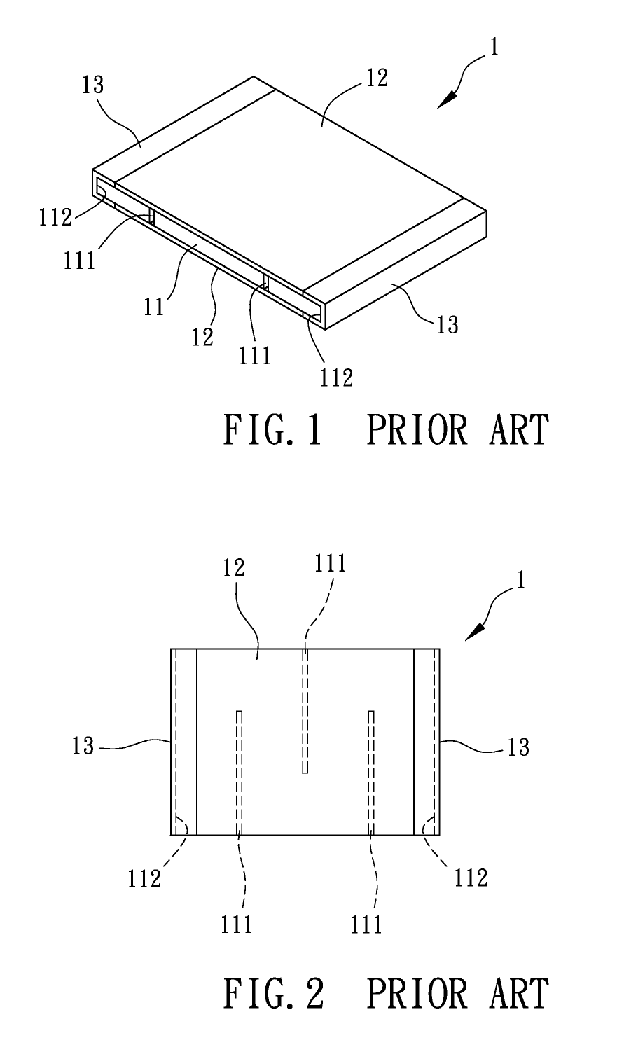

To sum up, by virtue of the heat dissipating layer 23 that facilitates heat dissipation of the resistor main body 21 during use, the temperature of the chip resistor is relatively low as compared to the conventional chip resistor 1 illustrated in FIGS. 1 and 2. Thus the resistance value and the resistance characteristic of the chip resistor 2 remain stable, and the material for making the chip resistor 2 may not be a heat-resistant material, thereby reducing manufacturing cost. Additionally, heat dissipating layer 23 made of metallic material ensures the structural strength of the chip resistor 2 when the thickness of the resistor main body 21 is reduced and/or the number of slits 211 is increased.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A method for manufacturing a chip resistor, said method comprising the following steps of:
a) sandwiching an electric-insulating material layer between an electric-conducting material layer and a heat-dissipating material layer to form a semi-product;
b) forming a plurality of resistor sections arranged in an array on the semi-product by
forming a plurality of first slots through the semi-product, the first slots extending in a first direction and being arranged in a plurality of rows, each row including a plurality of adjacent pairs of the first slots, and
forming a plurality of second slots through the semi-product, the second slots extending in a second direction perpendicular to the first direction and being arranged in a plurality of columns, each adjacent pair of the second slots cooperating with a corresponding adjacent pair of the first slots to surround and define one of the resistor sections, each of the resistor sections having a first layer which is a segment of the electric-conducting material layer, a second layer which is a segment of the heat-dissipating material layer, and a sandwiched layer which is a segment of the electric-insulating material layer;
c) for each resistor section, forming a plurality of slits on the second layer of the resistor section to form a resistor main body, the slits extending in the first direction and being arranged and spaced apart from one another in the second direction, the resistor main body having a pair of ends opposite to each other in the second direction and corresponding respectively to a pair of the first slots that define the resistor section;
d) for each resistor section, forming at least one dividing slot on the third layer of the resistor section, the dividing slot projectively crossing at least one of the slits of the resistor section and dividing the third layer of the resistor section into at least two portions that are spaced apart from each other in the second direction;
e) for each resistor section, forming two electrodes that are electrically and respectively connected to the ends of the resistor main body; and
f) trimming each of the resistor sections to obtain a chip resistor.

2. The method as claimed in claim 1, wherein, in step d), the dividing slot is formed to have two segments which form an obtuse angle therebetween.

3. The method as claimed in claim 1, wherein, in step d), the dividing slot is formed to have a plurality of segments in a zigzag arrangement, every adjacent two of the segments forming an obtuse angle therebetween.

4. The method as claimed in claim 1, wherein, in step c) and d), the slits and the dividing slot are formed by masking and etching the second layer and the third layer of each of the resistor sections.

5. The method as claimed in claim 1, wherein, in step e), the electrodes are formed by masking and electroplating.

6. The method as claimed in claim 1, wherein step a) includes the following sub-steps of:
coating a heat-conductive polymer material on one of the electric-conducting material layer and the heat-dissipating material layer;
stacking the other one of the electric-conducting material layer and the heat-dissipating material layer on the heat-conductive polymer material; and
heating the electric-conducting material layer and the heat-dissipating material layer under a vacuum condition to solidify the heat-conductive polymer material serving as the electric-insulating material layer, thereby forming the semi-product.

7. The method as claimed in claim 6, wherein the heat-conductive polymer material is polypropylene.

8. The method as claimed in claim 1, wherein the electric-conducting material layer is made of a material selected from the group consisting of copper, aluminum, copper alloy, aluminum alloy, and copper aluminum alloy.

9. The method as claimed in claim 1, wherein the heat-dissipating material layer is made of a material selected from the group consisting of copper, aluminum, copper alloy, aluminum alloy, and copper aluminum alloy.

10. The method as claimed in claim 1, wherein, in step c), the resistor main body further having a pair of lateral sides parallelly extending in the second direction and opposite to each other in the first direction, and every adjacent two of the slits is formed to extend from and penetrate through the lateral sides, respectively.
